(19) United States
(12) Patent Application Publication
(10) Pub. No.: US 2026/0146908 A1
(43) Pub. Date: May 28, 2026

(54) PIEZOELECTRIC HIGH-PRESSURE SENSOR

(71) Applicant: Kistler Holding AG, Winterthur (CH)

(72) Inventors: Julian Hoefler, Hilzingen-Riedheim (DE); Lukas Roth, Baden (CH); Stefan Brechbuhl, Weinfelden (CH)

(21) Appl. No.: 19/396,458

(22) Filed: Nov. 21, 2025

(30) Foreign Application Priority Data
Nov. 28, 2024 (EP) 24216171.9

(51) Int. Cl. G01L 9/00; G01L 19/14

(52) U.S. Cl. CPC G01L 9/008; G01L 19/14

(57) ABSTRACT

A piezoresistive pressure sensor for measuring the pressure of a medium in an environment includes a housing defining an interior, a base body disposed in the interior and connected to the housing and defining a diaphragm, and a measuring unit with a piezoresistive element disposed in the interior so as to detect a deflection of the diaphragm. The diaphragm confines a blind hole of the base body and an opening through the housing is arranged to communicate with the blind hole when the piezoresistive pressure sensor is exposed to the medium so as to deflect the diaphragm. A material bonding connection connects the base body directly to the housing in a mechanically tight manner while exhibiting a melting temperature greater than or equal to 250° C. An electrical conductor taps the piezoresistive element's change in resistance as electrical voltage and discharges the voltage into the environment.

### TECHNICAL FIELD

The invention relates to a piezoelectric high-pressure sensor that attaches a disc-shaped diaphragm across one open end of a cylindrical housing defining a hollow space containing a measuring unit that detects pressure incident on the diaphragm, wherein the measuring unit includes a measuring element made of piezoelectric material.

### BACKGROUND OF THE INVENTION

Piezoelectric sensors are well known and adapted for measuring a wide variety of physical variables such as pressure, force, strain, and acceleration. All piezoelectric sensors function according to the same principle. A piezoelectric material generates electrical charges Q under the impact of the physical variable to be measured. The electrical charges are tapped from the surfaces of the piezoelectric material by electrodes. The amount of electrical charges is proportional to the magnitude of the physical variables. This type of proportionality is also called linearity. The piezoelectric material and the electrodes constitute a measuring unit.

In general, piezoelectric pressure sensors comprise a housing and a diaphragm made of a mechanically resistant material such as stainless steel. The housing is hollow-cylindrical in shape and comprises a shell and a cavity. The diaphragm is disc-shaped with a central area and a peripheral area. The measuring unit is arranged within the cavity. By the central area, the diaphragm absorbs the pressure to be measured which it transmits to the measuring unit as an applied force. By the peripheral area, the diaphragm is connected to the shell by a bond between materials. In this way, the cavity is hermetically sealed and the measuring unit is protected from harmful influences from the environment. The diaphragm is configured to be flexible to transmit the pressure with as little mechanical resistance as possible. This flexibility is achieved by a small thickness of the diaphragm of less than/equal to 0.5 mm. In this way, the piezoelectric pressure sensor achieves high sensitivity, that is the amount of electrical charges for the pressure applied. The piezoelectric pressure sensor can be mounted at a measurement site via the shell, for example, by means of a standardized external thread.

Special piezoelectric high-pressure sensors have been developed for measuring a high pressure of more than 1 kbar. A high pressure of more than 1 kbar occurs during highly dynamic pressure changes such as explosions. A high measurement frequency is required to accurately measure such highly dynamic pressure changes. Furthermore, since the measurement frequency is limited by the natural frequency, piezoelectric high-pressure sensors have a high natural frequency. According to Decision XXXII-45 of the International Commission for Standardization and Testing of Small Arms and Ammunition (C.I.P.) of October 2014, piezoelectric high-pressure sensors must have a natural frequency of greater than/equal to 150 kHz. Typically, the maximum measurement frequency is ⅓ of the natural frequency.

Piezoelectric high-pressure sensors of this type are marketed by the applicant under the names Type 6213B and Type 6217A. Technical information regarding these sensors can be found in data sheet No. 6217A_003-622e_02.23. Type 6217A is configured for measuring a pressure of up to 2 kbar and has a natural frequency of more than 180 KHz. Type 6213B is adapted to measure a pressure of up to 10 kbar and has a natural frequency of more than 150 KHz.

For many materials, a high pressure of greater than 1 kbar exceeds the elastic limit of the material. This has to be avoided since exceeding the elastic limit causes disruption of the mechanical stability of the materials and occurrence of irreversible damage such as plastic deformation or breakage. If plastic deformation or breakage occurs, the linearity will no longer be maintained and ultimately failure of the piezoelectric high-pressure sensor will occur. Therefore, only relatively few materials are suitable for piezoelectric high-pressure sensors. High-alloy stainless steel has proven useful for the shell and the diaphragm, and single crystals made of SiO₂, GaPO₄ and the like have proven useful as the piezoelectric material of the measuring unit. High-alloy stainless steel is ductile, and the elastic limit of the shell and the diaphragm is determined in a tensile test as the 0.2% yield strength. On the other hand, single crystals of SiO₂, GaPO₄ are brittle and therefore, the elastic limit of the measuring unit is determined in a pressure test as the 0.2% compression limit.

The diaphragm transmits only a small proportion of the pressure to the measuring unit as the applied force whereby exceeding the 0.2% compression limit of the measuring unit is avoided. A larger proportion of the pressure is absorbed by the shell as a force. This partitioning of the pressure has an effect on the sensitivity of the piezoelectric high-pressure sensor. The sensitivity for type 6217A that is configured for measuring a pressure of 2 kbar is 13 pico coulumbs per bar (pC/bar). In contrast, type 6213B is configured for measuring a pressure of up to 10 kbar, i.e. five times higher, and a significantly smaller proportion of the pressure is transmitted into the piezoelectric material as the applied force, resulting in an accordingly low sensitivity of 1.2 pC/bar. This low sensitivity meets the minimum sensitivity criterion of 1.0 pC/bar of Decision XXXII-45 of the C.I.P. from October 2014.

The piezoelectric high-pressure sensor shell absorbs the majority of the pressure as a force and accordingly is solid in construction. This leads to a relatively large shell diameter. Type 6213B and Type 6217A both comprise an M12 external thread for mounting at the site of measurement.

However, there is often very limited space at the measurement site. For this reason, users of piezoelectric high-pressure sensors highly desire a reduction in shell diameter.

To this effect, a piezoelectric high-pressure sensor named Type 6215 is marketed by the applicant. Also in this case, technical information on Type 6215 can be found in data sheet No. 6217A_003-622e_02.23. Type 6215 is equipped with an M10 external thread for mounting at the measurement site, is configured for measuring a pressure of up to 6 kbar, has a natural frequency of more than 240 KHz and a sensitivity of 1.4 pC/bar.

### OBJECTS AND SUMMARY OF THE INVENTION

It is an object of the present invention to provide a piezoelectric high-pressure sensor that is superior to Types 6213B, 6215, and 6217A. In particular, the improved piezoelectric high-pressure sensor shall comprise a shell with a relatively small diameter of less than/equal to 10 mm and yet be capable of measuring a relatively high pressure of up to 10 kbar. In addition, the improved piezoelectric high-pressure sensor shall meet the requirements of Decision XXXII-45 of the C.I.P. from October 2014, i.e., have a natural frequency of greater than or equal to 150 kHz and a sensitivity of 1.0 pC/bar.

The objects have been attained by the features described herein.

The invention relates to a piezoelectric high-pressure sensor for measuring a pressure of up to 10 kbar; comprising a housing, a diaphragm, and a measuring unit, which housing is hollow-cylindrical in shape and comprises a shell and a cavity, which shell is designed to include at least one mounting means, wherein the piezoelectric high-pressure sensor can be mounted at a measurement site by said mounting means; which measuring unit is arranged within the cavity and comprises at least one measuring element made of piezoelectric material; which diaphragm is disc-shaped having a central area and a peripheral area, which diaphragm is configured to absorb the pressure to be measured by the central area and to transmit it to the measuring unit along a vertical axis, and which diaphragm is connected to the shell by the peripheral area by means of a bond between materials; wherein the measuring element is rod-shaped and functions according to the piezoelectric transverse effect; wherein the measuring element has a length along the vertical axis and a cross-sectional area normal to the vertical axis; wherein a ratio of the length to the cross-sectional area is in a range from greater than/equal to 1.0 mm⁻¹ to less than/equal to 1.5 mm⁻¹; and wherein the shell has a diameter of less than/equal to 10 mm.

The measuring range is increased to a pressure of up to 10 kbar compared to Type 6215 while the shell diameter of less than/equal to 10 mm is maintained and this affects the mounting of the piezoelectric high-pressure sensor at the measurement site. This is because according to Standard Allied Engineering Publication 97 (AEP-97) of the North Atlantic Treaty Organization (NATO) from October 2020, an M10 screw connection of a piezoelectric high-pressure sensor should have a tightening torque of no more than 20 nanometers (Nm). This tightening torque corresponds to a hold-down force of less than/equal to 20 kilonewtons (kN) which holds the piezoelectric high-pressure sensor within the mounting bore. This tightening torque ensures that a combination of hold-down force and applied force does not lead to harmful stress peaks with plastic deformation or breakage in the materials of the piezoelectric high-pressure sensor.

A pressure of 10 kilobar (kbar) at a hold-down force of less than/equal to 20 kN results in an impact surface of less than/equal to 20 square millimeters (mm²) which is equal to ⅓ of the surface of the disc-shaped diaphragm. Since the impact surface is relatively small, less than ⅓ of the pressure is transmitted into the piezoelectric material and, thus, the sensitivity of the piezoelectric high-pressure sensor is reduced. To meet the sensitivity of 1.0 pC/bar required according to Decision XXXII-45 of the C.I.P. from October 2014 in spite of this, the rod-shaped measuring element must be as long as possible. The reason is that the amount of electrical charge Q that the measuring element functioning according to the piezoelectric transverse effect generates under the impact of the pressure onto its lateral surfaces increases linearly with its length. The sensitivity is the ratio of the amount of electrical charges to the pressure applied.

Moreover, increasing the measuring range to a pressure of up to 10 kbar compared to Type 6215 also affects the diaphragm. The reason for this is that the piezoelectric material of the measuring unit is significantly more elastic than the material of the shell. According to Hooke's law, elasticity is the product of elastic modulus and length. The elastic modulus of the piezoelectric material is less than half that of the shell material. This elasticity results in additional bending along the vertical axis in the central area of the diaphragm which transmits the pressure to be measured into the measuring unit via the central area while being firmly bonded to the shell by a bond between materials via the peripheral area. This additional bending is manifested in tensile and compressive stresses in the thickness of the central area. In other words, when the central region of the diaphragm is defected by the pressure to be measured, to accommodate the diaphragm's distortion in shape caused by the deflection, which creates a bulge toward the piezoelectric material, i.e., in the direction of the applied force from the pressure to be measured, to accommodate the bulge the diaphragm's region that exists between a neutral plane through the diaphragm and the piezoelectric material must undergo compression. To accommodate such compression, the region of the diaphragm above the neutral plane and facing away from the piezoelectric material must become stretched under tensile forces in order to accommodate the bulge in the diaphragm. The diaphragm's metallic fibers that extend along the neutral plane are least subject to any of these compressive and tensile stresses. Measured in the direction along which the force to be measured acts on the diaphragm, these tensile and compressive stresses are highest in the extreme fibers that exist farthest from the neutral plane through the diaphragm in the diaphragm's central region that is being subjected to the bulging caused by the deflection. Furthermore, at less than/equal to 0.5 mm, the thickness of the central area of the diaphragm is small. A thickness dimension of less than or equal to 0.5 mm is approximately one order of magnitude greater than the size of the grain boundaries of the diaphragm material. Thus, the tensile and compressive stresses may shift these grain boundaries within the extreme fiber and may cause cracking of the diaphragm which inevitably leads to failure of the piezoelectric high-pressure sensor.

To keep the tensile and compressive stresses in the central area of the diaphragm small, the measuring element must be as short as possible. The relationship is linear: the smaller the length of the measuring element, the smaller are the tensile and compressive stresses in the central area of the diaphragm.

As a solution for the dilemma that the sensitivity of the piezoelectric high-pressure sensor must be high while the tensile and compressive stresses in the central area of the diaphragm have to be kept small, the cross-sectional area of the measuring element is increased according to the invention so that a ratio between length and cross-sectional area of the measuring element is in a range of greater than or equal to 1.0 mm⁻¹ to smaller than or equal to 1.5 mm⁻¹.

The reason is that increasing the cross-sectional area of the measuring element reduces the elasticity of the piezoelectric material quadratically, while the amount of electrical charge generated under the impact of the pressure onto the side surfaces of the measuring element is reduced linearly.

Compared to Type 6215, the piezoelectric high-pressure sensor according to the invention has the same diameter of the shell of less than or equal to 10 mm. Because of this identical diameter, Type 6215 and the piezoelectric high-pressure sensor according to the invention differ only slightly in weight. Moreover, since the natural frequency is inversely related to the weight, the natural frequency of the piezoelectric high-pressure sensor of the invention is greater than or equal to 150 kHz, i.e., similar in magnitude to that of Type 6215.

Advantageous developments of the invention are described below.

### BRIEF DESCRIPTION OF THE DRAWINGS

In the following, the invention will be explained in more detail by means of an exemplary embodiment with reference to figures in which

FIG. 1 shows a longitudinal section through a portion of a piezoelectric high-pressure sensor 10; and

FIG. 2 shows a cross-section of a portion of the piezoelectric high-pressure sensor 10 as shown in FIG. 1 along a section line A-A of FIG. 1.

Throughout the figures, identical reference numerals denote the same objects.

### DETAILED DESCRIPTION OF EXEMPLARY EMBODIMENTS THE INVENTION

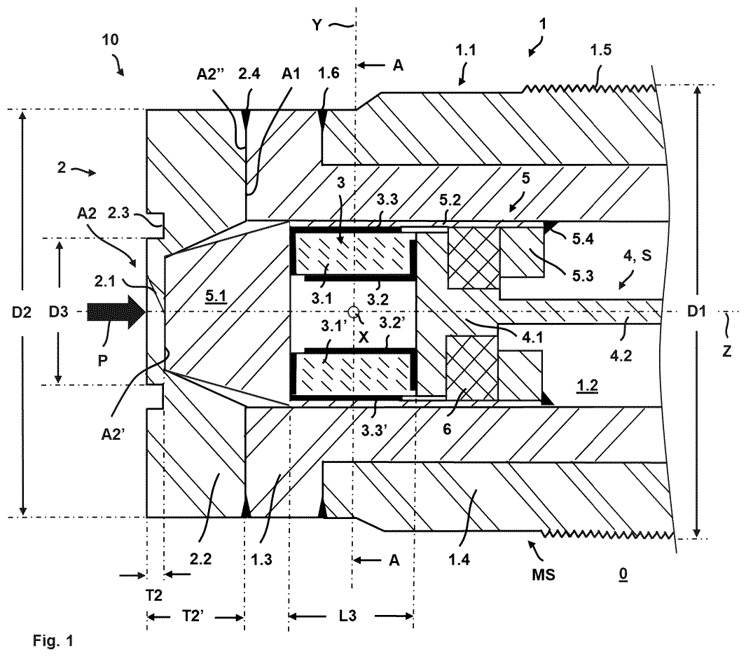

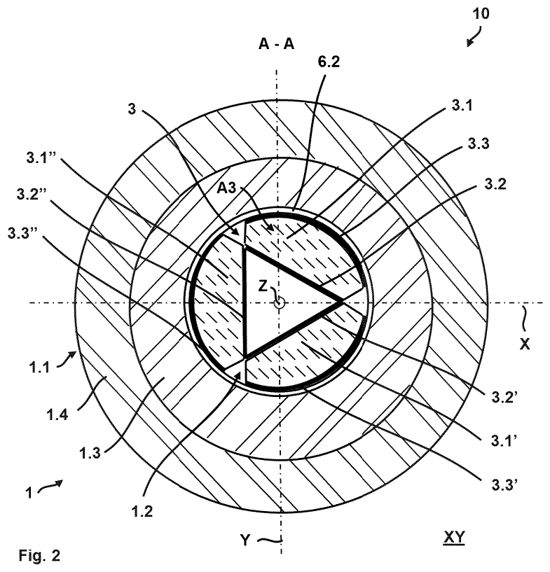

FIG. 1 shows a longitudinal section through a portion of the piezoelectric high-pressure sensor 10 along a vertical axis Z, also denoted as the longitudinal axis since the sensor 10 is configured to elongate along the longitudinal axis Z. FIG. 2 shows the piezoelectric high-pressure sensor 10 in cross-section along a section line A-A of a transverse plane XY spanned by an axis X and an axis Y. The three axes X, Y, Z are perpendicular to each other. The transverse plane XY is normal to the vertical axis Z. In the following, a direction along the axis X or the axis Y is also referred to as the “radial direction” because the piezoelectric high-pressure sensor 10 is configured essentially rotationally symmetrical with respect to the vertical axis Z. In the following, an object that is remote from the vertical axis Z along the axis X or the axis Y is also referred to as “radially spaced apart from the vertical axis Z”. Furthermore, a first object enclosed by a second object along the axis X or the axis Y is hereinafter referred to as “radially enclosed with respect to the vertical axis Z.”

The piezoelectric high-pressure sensor 10 comprises a housing 1, a diaphragm 2 and a measurement unit 3.

### The Housing 1

The housing 1 is configured to function, on the one hand, to protect the measurement unit 3 from harmful influences from the environment such as moisture, dust, touching and the like. The housing 1 also is configured to function to enable mounting of the piezoelectric high-pressure sensor 10 at a measurement site 0 schematically shown in FIG. 1.

The housing 1 is made of mechanically resistant material. Preferably, the material of the housing 1 is high-alloy stainless steel having a modulus of elasticity of greater than 200 kN/mm² and a 0.2% yield strength of more than/equal to 1200 MPa, preferably more than/equal to 1600 MPa. For example, the high-alloy stainless steel is material number 1.6358 stainless steel, available from SSAB, which has facilities worldwide, including in the United States in Mobile, Alabama.

The housing 1 comprises a shell 1.1 that defines a cavity 1.2 internally of the shell 1.1. Shell 1.1 is hollow-cylindrical in shape and extends along the vertical axis Z in the longitudinal section shown in FIG. 1. Shell 1.1 encloses the cavity 1.2 radially spaced apart from the vertical axis Z. The housing 1 has an outer diameter D1 of less than/equal to 10 mm in the radial direction.

Preferably, the shell 1.1 is manufactured from a plurality of parts and comprises a first shell part 1.3 and a second shell part 1.4. The shell 1.1 consisting of a plurality of parts functions to prevent a hold-down force that originates from the mounting of the piezoelectric high-pressure sensor 10 at the measurement site 0 from entering the measurement unit 3. It is not desirable that this hold-down force enters the measurement unit 3 because the hold-down force would distort the measurement of the pressure P and thus render the measurement less accorate.

According to section line A-A as shown in FIG. 2, the first shell part 1.3 is radially enclosed by the second shell part 1.4 with respect to the vertical axis Z. The outer diameter D1 of the housing 1 is also the outer diameter D1 of the second shell part 1.4. The first shell part 1.3 and the second shell part 1.4 merely abut against each other along the vertical axis Z. As shown in FIG. 1, the first shell part 1.3 and the second shell part 1.4 are connected to each other by a shell connection 1.6 by a bond between materials. Preferably, the shell connection 1.6 by a bond between materials is an annular welded joint that extends about 360° over the entire circumference of the shell 1.1. The shell connection 1.6 by a bond between materials forms a hermetic seal.

The second shell part 1.4 is formed to include at least one mounting means 1.5. Preferably, the mounting means 1.5 is formed as an M10 external thread. By means of the mounting means 1.5, the piezoelectric high-pressure sensor 10 can be mounted in a mounting bore located at the measurement site 0. The mounting bore is not shown in the Figure. Preferably, the mounting bore has an M10 internal thread. The M10 external thread and the M10 internal thread form an M10 screw connection. Because of the two-part configuration of the shell 1.1, second shell parts 1.4 with different external diameters can accommodate the same first shell part 1.3. Thus, only the second shell parts 1.4 need to be made to fit differently sized mounting bores at the measurement site 0. This configuration accordingly lends itself to efficiencies in manufacture and parts inventory and associated cost reduction.

According to Standard AEP-97 from October 2020, the M10 screw connection should have a tightening torque of no more than 20 Newton-meters (Nm). In the mounted state, the tightening torque of 20 Nm holds the piezoelectric high-pressure sensor 10 in the mounting bore with a hold-down force of less than/equal to 20 kN. A force F applied by the pressure P should not exceed the hold-down force because otherwise the piezoelectric high-pressure sensor 1 would be released out of the mounting bore. Therefore, the maximum permissible applied force is less than or equal to 20 kN.

The shell 1.1 comprises an end face A1 normal to the vertical axis Z and facing the diaphragm 2. End face A1 is preferably annular in shape and defined on the first shell part 1.3 as shown in FIG. 1.

### The Diaphragm 2

The diaphragm 2 is configured to function to absorb the pressure P to be measured and to transmit the pressure P to the measurement unit 3 as a force. In the longitudinal section shown in FIG. 1, the pressure P to be measured is schematically depicted as an arrow in bold typeface pointing in the direction that the force is being applied to the diaphragm 2.

The diaphragm 2 is made of mechanically resistant material. Preferably, the material of the diaphragm 2 is high-alloy stainless steel having a modulus of elasticity of greater than 200 kN/mm² and a 0.2% yield strength of greater than/equal to 1200 MPa, preferably greater than/equal to 1600 MPa. For example, the high-alloy stainless steel is a material having the material number 1.6358 or named Armox Advance, available from SSAB, for example.

The diaphragm 2 is disc-shaped overall. The diaphragm 2 has an outer diameter D2 of less than/equal to 8.5 mm in the radial direction.

The diaphragm 2 comprises a central region 2.1 and a peripheral region 2.2. In the longitudinal section as shown in FIG. 1, the central region 2.1 is situated on the vertical axis Z and is radially enclosed by the peripheral region 2.2 with respect to the vertical axis Z. The central region 2.1 and the peripheral region 2.2 are manufactured in one piece.

The diaphragm 2 has a thickness T2, T2′ measured along the vertical axis Z. The thickness T2, T2′ of the diaphragm 2 is significantly smaller than the outer diameter D2. The diaphragm has a thickness T2 in the central region 2.1, and the diaphragm 2 has a thickness T2′ in the peripheral region 2.2. The thickness T2 of the central region 2.1 is smaller than the thickness T2′ of the peripheral region 2.2. Preferably, the thickness T2 of the central region 2.1 is less than or equal to 0.5 mm. Preferably, the thickness T2′ of the peripheral region 2.2 is less than or equal to 3 mm.

Because of the small thickness T2 of the central region 2.1, the diaphragm 2 is configured to be flexible. As a result, the diaphragm 2 transmits the pressure P to be measured to the measurement unit 3 with as little resistance as possible.

In the central region 2.1, the diaphragm 2 comprises an impact surface A2. The impact surface A2 extends perpendicularly to the vertical axis Z. The impact surface A2 is arranged on a face of the diaphragm 2 that faces away from the cavity 1.2. A sealing surface 2.3 surrounds the impact surface A2 radially with respect to the vertical axis Z. The sealing surface 2.3 is configured to accommodate a sealant that is not shown in the Figure. The pressure P to be measured acts directly onto the impact surface A2. The size of the impact surface A2 is calculated from the ratio of the maximum permissible applied force of less than or equal to 20 kN and the pressure P. For a pressure P of up to 10 kbar, the size of the impact surface A2 is less than or equal to 20 mm². The impact surface A2 is preferably circular having a diameter D3 of less than or equal to 5.0 mm.

In the central region 2.1, the diaphragm 2 comprises a central surface A2′. The central surface A2′ extends perpendicularly to the vertical axis Z. The central surface A2′ is arranged on a face of the diaphragm 2 that faces the measurement unit 3. The central surface A2′ is preferably circular in shape.

The diaphragm 2 is connected to the first shell part 1.3 by the peripheral region 2.2. The peripheral region 2.2 has a greater thickness measured along the vertical axis Z compared to the central region 2.1. The peripheral region 2.2 defines a peripheral surface A2″. The peripheral surface A2″ extends perpendicularly to the vertical axis Z. The peripheral surface A2″ is arranged on a face of the diaphragm 2 that faces the shell 1.1. The peripheral surface A2″ is preferably annular in shape. The peripheral surface A2″ faces the end face A1 of the first shell part 1.3. The peripheral surface A2″ is in direct planar contact with the end face A1. Preferably, the peripheral surface A2″ is configured to have the same size as the end face A1.

At the peripheral region 2.2, the diaphragm 2 is connected to the first shell part 1.3 of the diaphragm 1.1 by a diaphragm connection 2.4 by a bond between materials. Preferably, the diaphragm connection 2.4 by a bond between materials is an annular welded connection extending about 360°. The diaphragm connection 2.4 by a bond between materials forms a hermetic seal.

### The Measurement Unit 3

The measurement unit 3 is configured to function to provide a measurement signal S for the pressure P to be measured.

The measurement unit 3 comprises at least one measuring element 3.1, 3.1′, 3.1″. Each measuring element 3.1, 3.1′, 3.1″ is configured to function to generate electrical charge under the impact of the pressure P to be measured.

The measurement unit 3 is made of piezoelectric material. Preferably, the piezoelectric material is a single crystal of SiO₂, GaPO₄ and the like. In the following example, the invention is explained in more detail using a piezoelectric material of a single crystal of SiO₂ or GaPO₄. However, this is in no way intended to limit the present invention. For practicing the present invention, one skilled in the art may also use other single crystal piezoelectric materials such as calcium gallogermanate (Ca₃Ga₂Ge₄O₁₄ or CGG), langasite (La₃Ga₅SiO₁₄ or LGS), tourmaline and the like.

Each measuring element 3.1, 3.1′, 3.1″ has a geometric shape that can be manufactured easily with great planeness. Each measuring element 3.1, 3.1′, 3.1″ is rod-shaped that defines two end faces and a plurality of side faces. The end faces are arranged normal to the vertical axis Z. The side faces are arranged along the vertical axis Z. The side faces are significantly larger than the end faces. An outer end face, as seen in the axial direction, of each measuring element 3.1, 3.1′, 3.1″ faces the diaphragm 2, and an inner end face, as seen in the axial direction, faces away from the diaphragm 2. The pressure P to be measured is transmitted to the measuring element 3.1, 3.1′, 3.1″ by the axially outer end face. Each measuring element 3.1, 3.1′, 3.1″ is defined by an inner side face and an outer side face, both as seen in the radial direction. The radially inner side face is oriented towards the vertical axis Z, and the radially outer side face is oriented to face away from the vertical axis Z.

Each measuring element 3.1, 3.1′, 3.1″ has a length L3 measured along the vertical axis Z. Preferably, the respective length L3 of the respective measuring element 3.1, 3.1′, 3.1″ is less than or equal to 3.0 mm, preferably less than or equal to 2.4 mm.

As schematically shown in FIG. 2, each measuring element 3.1, 3.1′, 3.1″ has a cross-sectional area A3 normal to the vertical axis Z. Preferably, the cross-sectional area A3 is in the range of greater than or equal to 1.5 mm² and smaller than or equal to 2.5 mm². Thus, in the case of three measuring elements 3.1, 3.1′, 3.1″ the total cross-sectional area A3 is in the range of greater than or equal to 4.5 mm² and than or equal to 7.5 mm².

Thus, the ratio of length L3 to cross-sectional area A3 of each measuring element 3.1, 3.1′, 3.1″ is in a range of greater than or equal to 1.0 mm² and smaller than or equal to 1.5 mm².

Each measuring element 3.1, 3.1′, 3.1″ is cut from the single crystal and configured to have a high sensitivity for the piezoelectric transverse effect and to generate the electric charge under the influence of the pressure P on the side faces. The SiO₂ cut from the single crystal for the piezoelectric transverse effect has a piezoelectric coefficient d₁₂=2.3 pC/N. The GaPO₄ cut from the single crystal for the piezoelectric transverse effect has a piezoelectric coefficient d₁₂=4.5 pC/N. The designation d₁₂ for the piezoelectric coefficient is not a reference symbol and is, therefore, not included in the Figures.

Preferably, the measurement unit 3 comprises exactly three measuring elements 3.1, 3.1′, 3.1″. The three measuring elements 3.1, 3.1′, 3.1″ consist of a first measuring element 3.1, a second measuring element 3.1′ and a third measuring element 3.1″. The three measuring elements 3.1, 3.1′, 3.1″ are identical. Using a quantity of three measuring elements 3.1, 3.1′, 3.1″ increases the sensitivity of the piezoelectric high-pressure sensor 10.

The sensitivity of the piezoelectric high-pressure sensor 10 is the ratio of the amount of electrical charge to the pressure P applied. The sensitivity is proportional to the product of the piezoelectric coefficient d₁₂ of the measuring element 3.1, 3.1′, 3.1″ and the ratio of length L3 to cross-sectional area A3 of the measuring element 3.1, 3.1′, 3.1″. For SiO₂ as the piezoelectric material which has a piezoelectric coefficient d₁₂=2.3 pC/N or GaPO₄ as the piezoelectric material which has a piezoelectric coefficient d₁₂=4.5 pC/N and for a ratio of length L3 to cross-sectional area A3 of the measuring element 3.1, 3.1′, 3.1″ in the range of greater than or equal to 1.0 mm⁻¹ and less than or equal to 1.5 mm⁻¹, the sensitivity is greater than or equal to 1.0 pC/bar and, thus, meets the requirement of Decision XXXII-45 of the C.I.P. from October 2014.

Single crystals of SiO₂ and GaPO₄ have elastic moduli with anisotropic coefficients of elasticity. The SiO₂ cut for the piezoelectric transverse effect has a coefficient of elasticity of 87 kN/mm² along the vertical axis Z. The GaPO₄ cut for the piezoelectric transverse effect has a coefficient of elasticity of 67 kN/mm² along the vertical axis Z.

The coefficient of elasticity of the piezoelectric material made from SiO₂ is smaller by more than a factor of two, or the coefficient of elasticity of the piezoelectric material made from GaPO₄ is smaller by a factor of three compared to the elastic modulus of the material of the shell 1.1. Thus, according to these values, under the effect of the pressure P, the piezoelectric material of the measurement unit 3 will be compressed more strongly along the vertical axis Z than the material of the shell 1.1. Furthermore, since the diaphragm 2 contacts the surface of the measuring element 3.1, 3.1′, 3.1″ indirectly via the central region 2.1 while being connected to the shell 1.1 by a bond between materials in the peripheral region 2.2, compression of the piezoelectric material of the measurement unit 3 leads to tensile and compressive stresses in the central region 2.1 of the diaphragm 2. The shorter the measuring element 3.1, 3.1′, 3.1″ is, the smaller will be the tensile and compressive stresses in the central region 2.1. For a length L3 of the measuring element 3.1, 3.1′, 3.1″ of less than or equal to 3.0 mm, preferably less than or equal to 2.4 mm, the tensile and compressive stresses at a pressure P of up to 10 kbar are at a harmless level for the mechanical stability of the central region 2.1. In this context, the adjective “harmless” means that it is highly unlikely that the tensile and compressive stresses in the central region 2.1 will lead to failure of the piezoelectric high-pressure sensor 10.

The measurement unit 3 comprises at least one signal electrode 3.2, 3.2′, 3.2″ and at least one ground electrode 3.3, 3.3′, 3.3″. The respective signal electrode 3.2, 3.2′, 3.2″ and the respective ground electrode 3.3, 3.3′, 3.3″ is configured to function to tap the electrical charge from the side faces of the respective measuring element 3.1, 3.1′, 2.1″.

The respective signal electrode 3.2, 3.2′, 3.2″ and the respective ground electrode 3.3, 3.3′, 3.3″ are made of electrically conductive material such as aluminum, silver and the like. The respective signal electrode 3.2, 3.2′, 3.2″ and the respective ground electrode 3.3, 3.3′, 3.3″ are arranged on the respective side faces and end faces of the respective measuring element 3.1, 3.1′, 3.1″. Arranging the respective signal electrode 3.2, 3.2′, 3.2″ and the respective ground electrode 3.3, 3.3′, 3.3″ on the respective side faces and end faces of the respective measuring element 3.1, 3.1′, 3.1″ is carried out by means of chemical vapor deposition, physical vapor deposition and the like. Preferably, each signal electrode 3.2, 3.2′, 3.2″ and each ground electrode 3.3, 3.3′. 3.3″ has a thickness of less than or equal to 200 nm.

Preferably, each signal electrode 3.2, 3.2′, 3.2″ consists of a first signal electrode 3.2, a second signal electrode 3.2′ and a third signal electrode 3.2″. Furthermore, each ground electrode 3.3, 3.3′, 3.3″ preferably consists of a first ground electrode 3.3, a second ground electrode 3.3′ and a third ground electrode 3.3″.

The first signal electrode 3.2 is deposited in certain areas on the radially inner side face of the first measuring element 3.1 and taps electrical charge from this radially inner side face. Furthermore, the first signal electrode 3.2 is deposited in certain areas on the axially inner end face of the first measuring element 3.1. The first ground electrode 3.3 is deposited in certain areas on the radially outer side face of the first measuring element 3.1 and taps electrical charge from this radially outer side face. Further, the first ground electrode 3.3 is arranged in certain areas on the axially outer end face of the first measuring element 3.1.

The second signal electrode 3.2′ is arranged in certain areas on the radially inner side face of the second measuring element 3.1′ and taps electrical charge from this radially inner side face. Furthermore, the second signal electrode 3.2′ is arranged in certain areas on the axially inner end face of the second measuring element 3.1′. The second ground electrode 3.3′ is arranged in certain areas on the radially outer side face of the second measuring element 3.1′ and taps electrical charge from this radially outer side face. Furthermore, the second ground electrode 3.3′ is arranged in certain areas on the axially outer end face of the second measuring element 3.1′.

The third signal electrode 3.2″ is arranged in certain areas on the radially inner side face of the third measuring element 3.1″ and taps electrical charge from this radially inner side face. Furthermore, the third signal electrode 3.2″ is arranged in certain areas on the axially inner end face of the third measuring element 3.1″. The third ground electrode 3.3″ is arranged in certain areas on the radially outer side face of the third measuring element 3.1″ and taps electrical charge from this radially outer side face. Furthermore, the third ground electrode 3.3″ is arranged in certain areas on the axially outer end face of the third measuring element 3.1″.

A measurement signal S is provided by the electrical charge tapped by the signal electrodes 3.2, 3.2′, 3.2″. A mass signal MS is provided by the electrical charge tapped by the ground electrodes 3.3, 3.3′, 3.3″.

### The Transmission Unit 4

The piezoelectric high-pressure sensor 10 comprises at least one transmission unit 4. The transmission unit 4 functions to transmit the electrical charge tapped by the at least one signal electrode 3.2, 3.2′, 3.2″ as a measurement signal S.

The transmission unit 4 is made of electrically conductive material such as high-alloy stainless steel. The transmission unit 4 comprises a cylindrical charge collector 4.1 and a rod-shaped charge transmitter 4.2. The charge collector 4.1 and the charge transmitter 4.2 may be manufactured in one piece or from a plurality of parts. When manufactured from a plurality of parts, these may be electrically and mechanically connected to each other by any type of mechanical connection such as a bond between materials, form fit, force fit and the like.

The transmission unit 4 extends along the vertical axis Z in the longitudinal section shown in FIG. 1. Preferably, the transmission unit 4 extends on the vertical axis Z. The charge collector 4.1 of the transmission unit 4 is oriented towards the diaphragm 2 while the charge transmitter 4.2 faces away from the diaphragm 2.

The charge collector 4.1 is in direct planar contact with the at least one signal electrode 3.2, 3.2′, 3.2″. Preferably, the signal electrode 3.2, 3.2′, 3.2″ is composed of the first signal electrode 3.2, the second signal electrode 3.2′ and the third signal electrode 3.2″, and the charge collector 4.1 is in direct planar contact with all three signal electrodes 3.2, 3.2′, 3.2″. The direct planar contact is configured such that the electrical charge tapped by the three signal electrodes 3.2, 3.2′, 3.2″ flows to the charge collector 4.1. Thus, the charge collector 4.1 is configured to collect the electrical charge from the three signal electrodes 3.2, 3.2′, 3.2″ and aggregates all of the collected charge to form a measurement signal S. The charge collector 4.2 transmits the measurement signal S.

### The Preloading Unit 5

The piezoelectric high-pressure sensor 10 comprises at least one preloading unit 5. The preloading unit 5 is configured to function to mechanically preload the measurement unit 3 against the transmission unit 4. Furthermore, the preloading unit 5 is configured to function to expand local pressure peaks in the diaphragm 2 and to reduce differences in the coefficients of thermal expansion of the materials of the housing 1 and the diaphragm 2 as well as of the piezoelectric material of the measurement unit 3. Finally, the preloading unit 5 is configured to function to transmit the electrical charge tapped by the at least one ground electrode 3.3, 3.3′, 3.3″ as a ground signal MS.

The preloading unit 5 is made of mechanically resistant material. Preferably, the material of the preloading unit 5 is a high-alloy stainless steel, available from SSAB for example.

In the longitudinal section as shown in FIG. 1, the preloading unit 5 extends along the vertical axis Z. Preferably, the preloading unit 5 comprises a compensation element 5.1 defining a solid shape of a truncated cone shown as a trapezoid in the cross-sectional view of FIG. 1, a hollow-cylindrical preloading sleeve 5.2 and a hollow-cylindrical preloading body 5.3.

The pressure P to be measured may have local pressure peaks that are significantly higher than the pressure P. Such local pressure peaks impinge onto the impact surface A2 of the diaphragm 2 in a locally restricted manner. Because of the small thickness of the diaphragm 2, and in order to prevent unimpeded transmission of the pressure peaks from the diaphragm 2 to the measurement unit 3 where they may undesirably exceed the 0.2% compression limit of the measurement unit 3, the compensation element 5.1 is arranged between the diaphragm 2 and the measurement unit 3 along the vertical axis Z. The compensation element 5.1 is in direct planar contact with the central surface A2′ of the diaphragm 2 by means of an end that faces the diaphragm 2. Thus, pressure peaks are transmitted into the compensation element 5.1 and are transmitted to the measurement unit 3 over the length of the compensation element 5.1 measured along the longitudinal axis Z. In this manner, the local pressure peaks are broadened, i.e., attenuated, to a magnitude that is harmless in the sense that the 0.2% compression limit of the measurement unit 3 is not exceeded.

The piezoelectric high-pressure sensor 10 is configured to be used at temperatures up to 200° C. At such high temperatures, the differences in the coefficient of thermal expansion of the material of the housing 1 and the diaphragm 2 and the coefficient of thermal expansion of the piezoelectric material of the measurement unit 3 lead to thermal stress that may result in undesirable damage to the piezoelectric high-pressure sensor 10. To reduce this thermal stress, the compensation element 5.1 has a coefficient of thermal expansion which is lower in magnitude than the coefficient of thermal expansion of the material of the housing 1 and the diaphragm 2 and lower than the coefficient of thermal expansion of the piezoelectric material of the measurement unit 3.

Preferably, the compensation element 5.1 is in direct planar contact with the at least one ground electrode 3.3, 3.3′, 3.3″ by means of an end that faces the measurement unit 3. Preferably, the ground electrode 3.3, 3.3′, 3.3″ is composed of the first ground electrode 3.3, the second ground electrode 3.3′, and the third ground electrode 3.3″, and the compensation element 5.1 is in direct planar contact with all three ground electrodes 3.3, 3.3′, 3.3″. The direct planar contact is designed to transmit the electrical charge tapped from the three ground electrodes 3.3, 3.3′, 3.3″ to the compensation element 5.1. Thus, the compensation element 5.1 collects the electrical charge from the three ground electrodes 3.3, 3.3′, 3.3″ to form a ground signal MS. Since the compensation element 5.1 is electrically connected to the diaphragm 2 and the diaphragm 2 itself is electrically connected to the shell 1.1, the ground signal MS is transmitted accordingly via the shell 1.

Preferably, the compensation element 5.1 and the preloading sleeve 5.2 are manufactured in one piece. However, they may also be manufactured from a plurality of parts mechanically connected to each other by a bond between materials.

The preloading sleeve 5.2 surrounds the measurement unit 3 radially spaced apart from the vertical axis Z. The measurement unit 3 and the charge collector 4.1 of the transmission unit 4 are arranged between the compensation element 5.1 and the preloading body 5.3 along the vertical axis Z.

By an end that faces the preloading body 5.3, the preloading sleeve 5.2 is connected to the preloading body 5.3 and to the first shell part 1.3 via a preloading sleeve connection 5.4 by means of a bond between materials. Preferably, the preloading sleeve connection 5.4 by a bond of materials is an annular welded connection that extends about 360° over the entire circumference of the end of the preloading sleeve 5.2.

The preloading sleeve connection 5.4 by a bond of materials is generated under a preloading force along the vertical axis Z of the measurement unit 3 against the charge collector 4.1. The preloading force seals microscopic pores within the piezoelectric material of the measurement unit 3 as well as in the material of the charge collector 4.1 by the material of the signal electrode 3.2, 3.2′, 3.2″. This prevents electrical charge to be retained within the microscopic pores where such retained charge would build a capacitance. This retention of electrical charge in microscopic pores would falsify the measurement of the pressure P, on the one hand because not all of the electrical charge is tapped and transmitted at the time of its generation, and on the other hand because the capacitance will be discharged over time leading to electrical charge tapped and transmitted over a more or less long period after its generation.

### The Insulating Element 6

The piezoelectric high-pressure sensor 10 comprises at least one insulating element 6. The insulating element 6 functions to electrically insulate the transmission unit 4 from the preloading unit 5.

The insulating element 6 consists of electrically insulating and mechanically rigid material such as ceramics, Al₂O₃ ceramics, sapphire and the like.

The insulating element 6 is hollow-cylindrical in shape. The insulating element 6 is arranged radially between the transmission unit 4 and the preloading unit 5.

The insulating element 6 surrounds the transmission unit 4 in the radial direction. The insulating element 6 is arranged on a side of the charge collector 4.1 that faces away from the measurement unit 3. The insulating element 6 is in direct planar contact with the charge collector 4.1. As schematically shown in FIG. 1, to ensure electrical isolation of the charge collector 4.1, which collects the measurement signal S, from the preloading sleeve 5.2, which carries the ground signal MS, the radial dimension of the insulating element 6 exceeds the radial dimension of the charge collector 4.1.

The insulating element 6 is radially enclosed by the preloading unit 6. Preferably, the insulating element 6 is in direct planar contact with the preloading body 5.3 and with the preloading sleeve 5.2.

List of reference symbols

| | |
|---|---|
| 0 | measurement site |
| 1 | housing |
| 1.1 | shell |
| 1.2 | cavity |
| 1.3 | first shell part |
| 1.4 | second shell part |
| 1.5 | mounting means |
| 1.6 | shell connection by a bond between materials |
| 2 | diaphragm |
| 2.1 | central area |
| 2.2 | peripheral area |
| 2.3 | sealing surface |
| 2.4 | diaphragm connection by a bond between materials |
| 3 | measurement unit |
| 3.1, 3.1′, 3.1″ | measuring element |
| 3.2, 3.2′, 3.2″ | signal electrode |
| 3.3, 3.3′, 3.3″ | ground electrode |
| 4 | transmission unit |
| 4.1 | charge collector |
| 4.2 | charge transmitter |
| 5 | preloading unit |
| 5.1 | compensation element |
| 5.2 | preloading sleeve |
| 5.3 | preloading body |
| 5.4 | preloading sleeve connection by a bond between |
| | materials |
| 6 | insulating element |
| 10 | piezoelectric high-pressure sensor |
| A-A | section line |
| A1 | end face of the first shell part |
| A2 | impact surface of the diaphragm |
| A2′ | central surface of the diaphragm |
| A2″ | peripheral surface of the diaphragm |
| A3 | cross-sectional area of the measuring element |
| D1 | outer diameter of the housing |
| D2 | outer diameter of the diaphragm |
| D3 | diameter of the impact surface of the diaphragm |
| L3 | length of the measuring element |
| MS | ground signal |
| P | pressure |
| S | measurement signal |
| T2 | thickness of the central area |
| T2′ | thickness of the peripheral area |
| X | horizontal axis |
| XY | horizontal plane |
| Y | longitudinal axis |
| Z | vertical axis |

What is claimed is:

1. A piezoelectric high-pressure sensor for measuring a pressure of up to 10 kbar; the sensor comprising:
a housing, a diaphragm and a measuring unit;
wherein said housing is hollow-cylindrical in shape and comprises a shell that elongates along a longitudinal axis and a cavity, which shell is formed to include at least one mounting means, which is configured and disposed to permit the piezoelectric high-pressure sensor to be mounted at a measurement site;
which measuring unit is arranged in the cavity and comprises at least one measuring element made of piezoelectric material;
which diaphragm is disc-shaped and defines a central area and a peripheral area spaced radially from the central area, which diaphragm is configured to receive the pressure to be measured at the central area and to transmit the pressure along the longitudinal axis into the measuring unit, and which diaphragm is connected to the shell at the peripheral area by a bond between the shell and the peripheral area of the diaphragm;
wherein the measuring element is rod-shaped and functions according to a piezoelectric transverse effect;
wherein the measuring element has a length along the longitudinal axis and a cross-sectional area normal to the longitudinal axis;
wherein a ratio of the length to the cross-sectional area is in a range from greater than or equal to 1.0 mm⁻¹ to less than or equal to 1.5 mm⁻¹; and
wherein the shell has a diameter of less than or equal to 10 mm.

2. The piezoelectric high-pressure sensor according to claim 1, wherein the length of the measuring element is less than or equal to 3.0 mm.

3. The piezoelectric high-pressure sensor according to claim 1, wherein the length of the measuring element is less than or equal to 2.4 mm.

4. The piezoelectric high-pressure sensor according to claim 1, wherein the measuring unit comprises exactly three measuring elements.

5. The piezoelectric high-pressure sensor according to claim 4, wherein each of the three measuring elements has a cross-sectional area in the range of greater than or equal to 1.5 mm² and smaller than or equal to 2.5 mm²; and
wherein the total cross-sectional area of the three measuring elements is in the range of greater than or equal to 4.5 mm² and smaller than or equal to 7.5 mm².

6. The piezoelectric high-pressure sensor according to claim 1, wherein the piezoelectric material of the measuring element is a single crystal of SiO₂; and
wherein the piezoelectric material of SiO₂ has a coefficient of elasticity of 87 kN/mm² along the longitudinal axis.

7. The piezoelectric high-pressure sensor according to claim 6, wherein the shell is made of mechanically resistant material having a modulus of elasticity of greater than 200 kN/mm²; and
wherein the coefficient of elasticity of the piezoelectric material of SiO₂ is smaller by more than a factor of two than that of the material of the shell such that under the effect of the pressure the piezoelectric material of the measuring element is compressed more strongly along the longitudinal axis than the material of the shell is compressed along the longitudinal axis.

8. The piezoelectric high-pressure sensor according to claim 1, wherein the piezoelectric material of the measuring element is a single crystal of GaPO₄; and
wherein the piezoelectric material of GaPO₄ has a coefficient of elasticity of 67 kN/mm² along the longitudinal axis.

9. The piezoelectric high-pressure sensor according to claim 8, wherein the shell is made of mechanically resistant material having a modulus of elasticity of greater than 200 kN/mm²; and
wherein the coefficient of elasticity of the piezoelectric material of GaPO₄ is smaller by a factor of three than that of the material of the shell such that under the effect of the pressure the piezoelectric material of the measuring element is compressed more strongly along the longitudinal axis than the material of the shell is compressed along the longitudinal axis.

10. The piezoelectric high-pressure sensor according to claim 1, wherein the central area of the diaphragm is in an indirect planar contact with the measuring element such that compression of the piezoelectric material of the measuring element causes tensile and compressive stresses in the central area of the diaphragm;
wherein the central area of the diaphragm has a thickness of less than or equal to 0.5 mm measured along a direction that is normal to the longitudinal axis; and
wherein for a length of the measuring element of less than or equal to 2.4 mm measured along the longitudinal axis, the tensile and compressive stresses at a pressure of up to 10 kbar are at a level that is harmless for the mechanical stability of the central area of the diaphragm.

11. The piezoelectric high-pressure sensor according to claim 1, wherein the central area of the diaphragm is in an indirect planar contact with the measuring element such that compression of the piezoelectric material of the measuring element causes tensile and compressive stresses in the central area of the diaphragm; and
wherein the central area of the diaphragm has a thickness of less than or equal to 0.5 mm measured along a direction that is normal to the longitudinal axis; and wherein for a length of the measuring element of less than or equal to 3.0 mm measured along the longitudinal axis, the tensile and compressive stresses at a pressure of up to 10 kbar are at a level that is harmless for the mechanical stability of the central area of the diaphragm.

12. The piezoelectric high-pressure sensor according to claim 1, wherein the mounting means is configured to a mounting bore forming an M10 screw connection having a tightening torque of no more than 20 Nm in a mounted state and wherein the piezoelectric high-pressure sensor is held in the mounting bore with a hold-down force of less than or equal to 20 kN.

13. The piezoelectric high-pressure sensor according to claim 12, wherein the diaphragm defines an impact surface that extends perpendicularly to the longitudinal axis and is disposed on a face of the diaphragm that faces away from the cavity such that the pressure to be measured acts directly onto the impact surface by an impact force; and
wherein the dimension of the impact surface is such that a combination of the hold-down force and the impact force does not lead to harmful stress peaks with plastic deformation or breakage in the materials of the piezoelectric high-pressure sensor.

14. The piezoelectric high-pressure sensor according to claim 13, wherein for a pressure of 10 kbar the size of the impact surface is smaller than or equal to 20 mm².

15. The piezoelectric high-pressure sensor according to claim 1, wherein the piezoelectric material of the measuring element is a single crystal that has a piezoelectric coefficient for the piezoelectric transverse effect that renders the sensitivity of the piezoelectric high-pressure sensor to be proportional to the product of the piezoelectric coefficient of the piezoelectric material of the measuring element and the ratio of the length to the cross-sectional area of the measuring element.

16. The piezoelectric high-pressure sensor according to claim 15, wherein for SiO₂ as the piezoelectric material of the measuring element, the piezoelectric coefficient equals 2.3 pC/N; and
wherein for the ratio of length to cross-sectional area of the measuring element in the range of greater than or equal to 1.0 mm⁻¹ and less than or equal to 1.5 mm⁻¹, the sensitivity of the piezoelectric high-pressure sensor is greater than or equal to 1.0 pC/bar.

17. The piezoelectric high-pressure sensor according to claim 15, wherein for GaPO₄ as the piezoelectric material of the measuring element the piezoelectric coefficient is 4.5 pC/N; and
wherein for the ratio of length to cross-sectional area of the measuring element in the range of greater than or equal to 1.0 mm⁻¹ and less than or equal to 1.5 mm⁻¹, the sensitivity of the piezoelectric high-pressure sensor is greater than or equal to 1.0 pC/bar.
